(19) United States
(12) Patent Application Publication
(10) Pub. No.: US 2008/0011268 A1
(43) Pub. Date: Jan. 17, 2008

(54) Intake valve for a combustion engine

(75) Inventor: George McLure Sawyer, Norwich, CT (US)

Correspondence Address: HEDMAN & COSTIGAN P.C., 1185 AVENUE OF THE AMERICAS, NEW YORK, NY, 10036, US

(73) Assignee: The Weinberger Group

(21) Appl. No.: 11/487,678

(22) Filed: Jul. 17, 2006

(51) Int. Cl. F02B 31/00; F02N 3/00

(52) U.S. Cl. 123/306; 123/188.7; 123/188.3

(57) ABSTRACT

An air intake valve for use in an internal combustion engine having at least one combustion chamber, including a valve stem having a valve stem surface and a valve body having a top valve body surface with at least a portion of one or more of the valve stem surface and the top valve body surface having an irregular surface to create swirl in the combustion chamber.

### FIELD OF THE INVENTION

The present invention relates generally to the field of air intake into the combustion chamber of internal combustion engines, and more particularly to the intake valves used therein.

### BACKGROUND OF THE INVENTION

It is well known that internal combustion engines work on the explosion of a mixture of fuel and air in the combustion chamber. During the combustion cycle, the intake valve opens into the combustion chamber to permit- the flow of air into the combustion chamber as fuel is introduced. The fuel and air mix in the combustion chamber and a spark is generated to ignite the fuel in the presence of oxygen, causing the explosion in the combustion chamber.

It is also known that the more homogeneous the mixture of fuel and air, the better and more efficient the explosion in the combustion chamber. As such it is beneficial to create a complete mixture of the fuel and air in the combustion chamber to improve efficiency of the engine.

There have been a number of devices and methods described for creating a more complete mixture of fuel and air in the combustion chamber. Generally, these devices seek to create turbulence and/or air swirl in the combustion chamber.

For example, U.S. Pat. No. 6,510,837 describes a cylinder head and intake port arrangement for multiple valve internal combustion engines that promotes turbulence in the combustion chamber by inducing a tumble action of the air flow from the valve seats. In another example, U.S. Pat. No. 6,550,446 describes a intake flow device to manipulate airflow in an air entry chamber of a positive displacement internal combustion engine, where the device is adaptable to various air entry chamber shapes.

Similarly, U.S. Pat. No. 6,598,585 describes a swirl generating intake manifold with a longitudinally oriented partition wall in the manifold, where there is a control flap to at least partially close the entrance area to one of the manifold sections. Additionally, U.S. Pat. No. 6,932,049 describes a wing structure of an air swirling device having a body for mounting in an air cleaner, with a plurality of wings mounted on the body to create a swirl into the combustion chamber.

However, the methods and devices of the prior art generally require modifications to major components and/or additional parts used in the engine.

It is therefore an object of the present invention to provide an inexpensive and simple way to improve the efficiency of an internal combustion engine by improving the fuel/air mixture in the combustion chamber. It is a further object to accomplish improved fuel/air mixture in the combustion chamber without the need for additional parts.

### SUMMARY OF THE INVENTION

This and other objects are achieved by the present invention which is directed to an air intake valve for use in an internal combustion engine having at least one combustion chamber, at least a portion of the surface of one or more of the valve stem and the valve body surface comprises an irregular surface, wherein the irregular surface creates a swirl in the normal air flow entering the combustion chamber when the intake valve opens.

In its preferred embodiment, the irregular surface comprises one or more protuberances, voids or a combination thereof on at least a portion of an exterior surface of the intake valve. Most preferably, the irregular surface comprises one or more protuberances in the form of vanes placed on the top surface of the valve body. The most preferred vanes are arcuate along the top surface of the valve body to create air swirl in the combustion chamber.

Alternatively, but also preferred, is an irregular surface comprising one or more voids in the top surface of the valve body. Similarly, the most preferred voids are formed as arcuate channels or grooves on the top surface of the valve body that create swirl in the combustion chamber.

Of course, the irregular surface can be on a portion of the valve stem, a portion of the valve body surface or a combination of these surfaces, as long as there is created a turbulence in the form of a swirl, in the combustion chamber. Depending on the location of the irregular surface, and the form that the irregular surface takes, the size and shape of the irregular surface may vary while maintaining the spirit and scope of the invention.

### BRIEF DESCRIPTION OF THE DRAWINGS

The present invention will be better understood when considered in view of the attached drawings, in which like reference characters indicate like parts. The drawings, however, are presented merely to illustrate the preferred embodiment of the invention without limiting the invention in any manner whatsoever.

FIG. 1 is a top perspective view of an air intake valve in accordance with the preferred embodiment of the present invention having protuberances on the upper surface of the valve body.

FIG. 2 is a side elevation of the preferred embodiment of the air intake valve shown in FIG. 1.

FIG. 3 is a top perspective view of an air intake valve in accordance with an alternative preferred embodiment of the present invention having voids on the upper surface of the valve body.

### DETAILED DESCRIPTION OF THE PREFERRED EMBODIMENTS

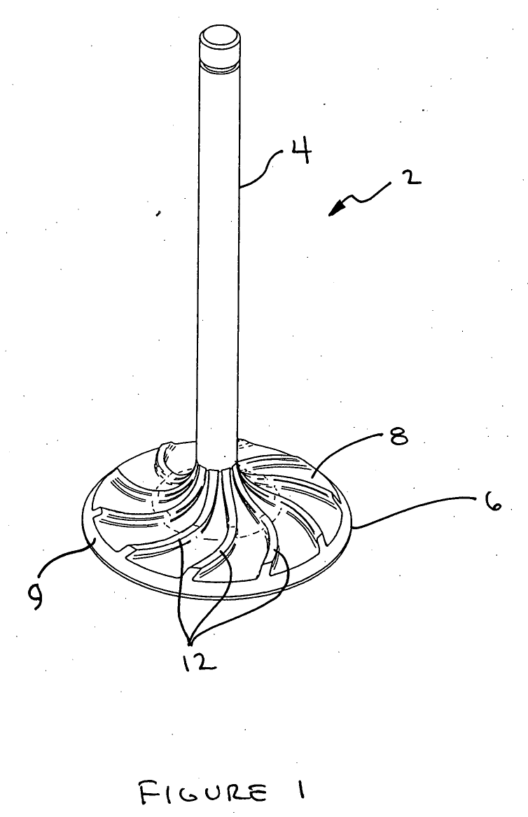

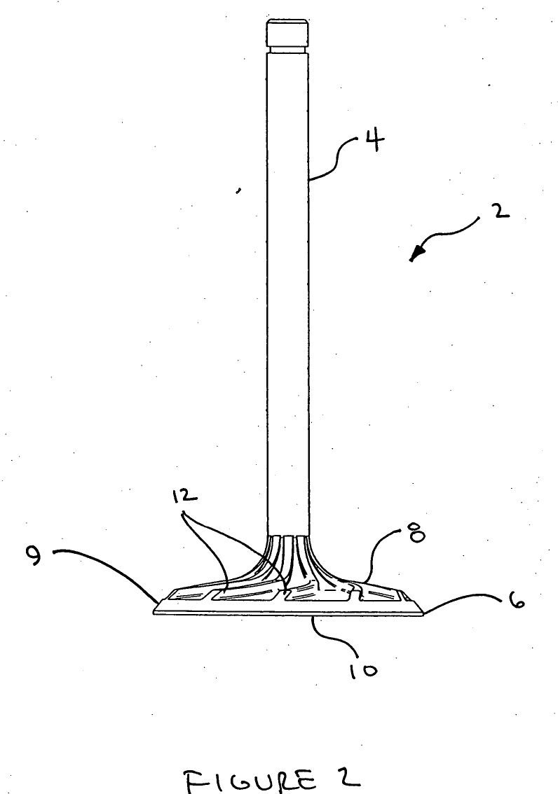

As shown in the drawings, and particularly FIGS. 1 and 2, the present invention is directed to an air intake valve 2, for use in an internal combustion engine. The intake valve 2 comprises a valve stem 4 and a valve body 6 which seats in the opening to the combustion chamber. The valve body 6 includes a top valve body surface 8, which creates a surface in the intake manifold when the valve 2 is closed, and a bottom valve body surface 10, which creates a surface in the combustion chamber when the intake valve is closed.

During operation, the valve stem 4 is acted on by lifters, rocker arms, pushrods and springs that lower and raise the intake valve 2, and the valve body 6, thereby opening and closing the air intake opening to the combustion chamber. When the spring raises the intake valve 2, the valve body 6 raises and seats in the valve seat to seal the combustion chamber. When the lifter, rocker arm and pushrod lowers the intake valve 2, the valve body 6 drops down into the combustion chamber to permit air to flow into the combustion chamber. More particularly, when the intake valve 2 is open, air is permitted to flow from the intake manifold, past the open intake valve 2 and into the combustion chamber.

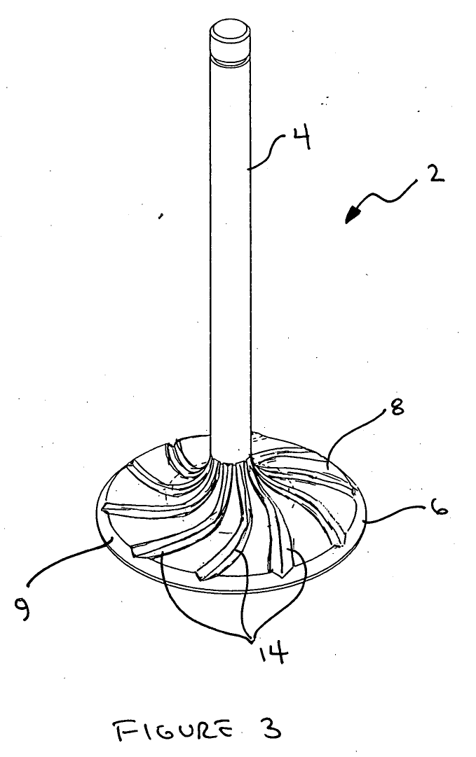

The intake valve 2 of the present invention includes an irregular surface on at least a portion of an exterior surface of the intake valve 2. As shown in FIGS. 1 and 3, it is preferred that the irregular surface is located on at least a portion of the top surface 8 of the valve body 6. Of course, the irregular surface can be on one or more areas of the intake valve 2, including on at least a portion of the valve stem 4, etc., instead of and/or in addition to the top surface 8 of the valve body 6.

The irregular surface can be formed of one or more protuberances, voids or a combination of protuberances and voids on the exterior surfaces capable of creating a swirl of the air entering the combustion chamber.

In the most preferred embodiment of FIG. 1, the irregular surface is formed on the top surface 8 of the valve body 6 as a plurality of protuberances in the form of vanes 12 extending upwardly from and radially about the top surface 8. The vanes 12 preferably take the shape of an arc radiating outwardly from about the area of the valve stem to the outer perimeter of the top surface 8 of the valve body 6.

In this regard, any suitable shape, dimension and combination of protuberances and/or voids used to create the intended swirl in the flow of air into the combustion chamber may be incorporated into a surface of the intake valve 2 under the present invention. As such, any one or more of bumps, divots, vanes, ruts, grooves, flutes, etc., that can create swirl in the air flow from the intake manifold into the combustion chamber may be used.

In this regard, the one or more protuberances and/or voids are formed so as to create a swirling action of the air entering the combustion chamber. As such, an irregular surface created from protuberances in the form of one or more arcuate vanes 12, as shown in FIG. 1, or voids in the form of one or more arcuate grooves 14, as shown in FIG. 3, is preferred.

Variations, modifications and alterations to the preferred embodiment of the present invention described above will make themselves apparent to those skilled in the art. All such changes are intended to fall within the spirit and scope of the present invention, limited solely by the appended claims.

All patents referred to herein are hereby incorporated by reference.

1. An air intake valve for use in an internal combustion engine having at least one combustion chamber, the air intake valve comprising a valve stem having a valve stem surface and a valve body having a top valve body surface with a valve seat mating surface at an outer perimeter, wherein at least a portion of one or more of the valve stem surface and the top valve body surface comprises an irregular surface to create air swirl from the air entering the combustion chamber comprising one or more protuberances, voids or a combination thereof formed on at least a portion of the top valve body surface and terminating at the valve seat mating surface.

2-3. (canceled)

4. The air intake valve of claim 1 wherein the irregular surface is formed of one or more protuberances in the form of one or more vanes on the top valve body surface.

5. The air intake valve of claim 4 wherein the one or more vanes are formed in an arcuate configuration.

6. The air intake valve of claim 5 wherein the one or more arcuate vanes radiate from about where the valve stem meets the top valve body surface to the valve seat mating surface at the outer perimeter of the top valve body surface.

7. The air intake valve of claim 1 comprising a plurality of arcuate vanes on the top valve body surface radiating from about where the valve stem meets the top valve body surface to the valve seat mating surface at the outer perimeter of the top valve body surface.

8. The air intake valve of claim 1 wherein the irregular surface is also included on at least a portion of the valve stem surface.

9. The air intake valve of claim 1 wherein the irregular surface is formed of one or more voids in the form of one or more grooves on the top valve body surface.

10. The air intake valve of claim 9 wherein the one or more grooves are formed in an arcuate configuration.

11. The air intake valve of claim 10 wherein the one or more arcuate grooves radiate from about where the valve stem meets the top valve body surface to the valve seat mating surface at the outer perimeter of the top valve body surface.

12. The air intake valve of claim 1 comprising a plurality of arcuate grooves on the top valve body surface radiating from about the valve stem to the valve seat mating surface at the outer perimeter of the top valve body surface.
